(19) United States
(12) Patent Application Publication
(10) Pub. No.: US 2010/0055446 A1
(43) Pub. Date: Mar. 4, 2010

(54) PREPARATION OF POLYMER DISPERSIONS IN THE PRESENCE OF ORGANIC POLYMER PARTICLES

(75) Inventors: Hermann Seyffer, Heidelberg (DE); Marc Schroeder, Canton, MI (US); Peter Schlichting, Bratislava (SK); Bernd Bruchmann, Freinsheim (DE)

Correspondence Address: OBLON, SPIVAK, MCCLELLAND MAIER & NEUSTADT, L.L.P., 1940 DUKE STREET, ALEXANDRIA, VA, 22314, US

(73) Assignee: BASF SE, Ludwigshafen (DE)

(21) Appl. No.: 12/517,238

(22) PCT Filed: Dec. 11, 2007
(86) PCT No.: PCT/EP07/63679

§ 371 Date: Jun. 2, 2009

(30) Foreign Application Priority Data
Dec. 15, 2006 (EP) 06126273.9

(51) Int. Cl. B32B 27/10; C08L 33/00; C08L 33/10; C08L 33/18; B32B 5/16

(52) U.S. Cl. 428/327; 524/800; 524/832; 524/836; 428/537.5; 428/481; 428/512; 428/412

(57) ABSTRACT

Aqueous polymer dispersion having a solids content greater than 50% by weight, obtainable by emulsion polymerization of monomers in the presence of organic polymers (organic particles for short) which are dispersible in the aqueous phase without surface-active assistants.

The invention relates to aqueous polymer dispersions which are obtainable by emulsion polymerization of monomers in the presence of organic polymer particles (organic particles for short) which are dispersible in the aqueous phase without surface-active assistants.

The invention also relates to the use of this aqueous polymer dispersion as a binder in paper coating slips.

For many uses, in particular the paper coating slips, polymer dispersions which have as high a solids content as possible in combination with as low a viscosity as possible are desired.

Paper coating slips generally also contain pigments and further assistants in addition to binder and water.

For simple and problem-free processing of the aqueous paper coating slip, it is desired that the paper coating slip have a low viscosity overall. A low viscosity also permits a higher solids content. Since less water has to be removed during drying, energy costs can also be reduced.

Furthermore, the performance characteristics of the coated paper, for example resistance to mechanical loads, in particular pick resistance, optical appearance, e.g. smoothness and gloss, and the printability should be as good as possible.

WO 02/48459 discloses paper coating slips whose viscosity is reduced by addition of highly crosslinked polyester amides.

WO 2005/003186 describes a process in which monomers are polymerized in the presence of dendritic polymers. The solids contents are below 50% by weight.

Polymer dispersions having as high a solids content as possible and a low viscosity, and paper coating slips having a low viscosity and good performance characteristics, were objects of the present invention.

Accordingly, the polymer dispersions defined above were found. Paper coating slips which comprise these polymer dispersions were also found.

The aqueous polymer dispersions according to the invention are obtainable by emulsion polymerization of monomers in the presence of organic polymer particles ((in)organic particles for short) which are dispersible in the aqueous phase without surface-active assistants. The polymer formed from the monomers is therefore an emulsion polymer.

### Regarding the Composition of the Emulsion Polymer

The emulsion polymer preferably comprises at least 40% by weight, preferably at least 60% by weight, particularly preferably at least 80% by weight, of so-called main monomers.

The main monomers are selected from C₁-C₂₀-alkyl (meth)acrylates, vinyl esters of carboxylic acids comprising up to 20 carbon atoms, vinylaromatics having up to 20 carbon atoms, ethylenically unsaturated nitriles, vinyl halides, vinyl ethers of alcohols comprising 1 to 10 carbon atoms, aliphatic hydrocarbons having 2 to 8 carbon atoms and one or two double bonds or mixtures of these monomers.

For example, alkyl (meth)acrylates having a C₁-C₁₀-alkyl radical, such as methyl methacrylate, methyl acrylate, n-butyl acrylate, ethyl acrylate and 2-ethylhexyl acrylate, may be mentioned.

Mixtures of the alkyl (meth)acrylates are also particularly suitable.

Vinyl esters of carboxylic acids having 1 to 20 carbon atoms are, for example, vinyl laurate, vinyl stearate, vinyl propionate, vinyl versatate and vinyl acetate.

Suitable vinylaromatic compounds are vinyltoluene, α- and p-methylstyrene, α-butylstyrene, 4-n-butylstyrene, 4-n-decylstyrene and preferably styrene. Examples of nitriles are acrylonitrile and methacrylonitrile.

The vinyl halides are chlorine-, fluorine- or bromine-substituted ethylenically unsaturated compounds, preferably vinyl chloride and vinylidene chloride.

For example, vinyl methyl ether or vinyl isobutyl ether may be mentioned as vinyl ethers. A vinyl ether of alcohols comprising 1 to 4 carbon atoms is preferred.

Ethylene, propylene, butadiene, isoprene and chloroprene may be mentioned as hydrocarbons having 2 to 8 carbon atoms and one or two olefinic double bonds.

Preferred main monomers are C₁-C₁₀-alkyl (meth)acrylates and mixtures of alkyl (meth)acrylates with vinylaromatics, in particular styrene (also referred to overall as polyacrylate binder) or hydrocarbons having two double bonds, in particular butadiene, or mixtures of such hydrocarbons with vinylaromatics, in particular styrene (also referred to overall as polybutadiene binder).

In the case of polybutadiene binders, the weight ratio of butadiene to vinylaromatics (in particular styrene) may be, for example, from 10:90 to 90:10, preferably from 20:80 to 80:20.

The emulsion polymer therefore preferably comprises at least 60% by weight of butadiene or mixtures of butadiene and styrene or at least 60% by weight of C₁ to C₂₀ alkyl (meth)acrylates or mixtures of C₁ to C₂₀ alkyl (meth)acrylates and styrene.

Polybutadiene binders are particularly preferred. Particularly preferably, the emulsion polymer therefore comprises at least 40% by weight, preferably at least 60% by weight, particularly preferably at least 80% by weight, in particular at least 90% by weight, of hydrocarbons having two double bonds, in particular butadiene, or mixtures of such hydrocarbons with vinylaromatics, in particular styrene.

In addition to the main monomers, the emulsion polymer may comprise further monomers, e.g. monomers having carboxyl, sulfo or phosphonic acid groups. Carboxyl groups are preferred. For example, acrylic acid, methacrylic acid, itaconic acid, maleic acid or fumaric acid and acotinic acid may be mentioned. In a preferred embodiment, the emulsion polymers have a content of ethylenically unsaturated acids of, in particular, from 0.05% by weight to 5% by weight.

Further monomers are, for example, also monomers comprising hydroxyl groups, in particular C₁-C₁₀-hydroxyalkyl (meth)acrylates, or amides, such as (meth)acrylamide.

### Regarding the Organic Particles

The inorganic or organic polymer particles (organic particles for short) are those which are dispersible in the aqueous phase without surface-active assistants. Accordingly, preferably no surface-active assistants are used for dispersing the particles in water, but concomitant use of such assistants is in principle possible.

They are in particular organic particles which are dispersible in water owing to their content of hydrophilic groups.

Crosslinked or branched organic, synthetic polymers and particularly preferably dendritic polymers may be mentioned as organic polymer particles.

In the context of the present invention, the stable distribution of dendritic polymers in water is designated in principle as a dispersion of polymer particles. This definition is justified in particular by the particle structure, even if the respective polymer particles are to consist only of a single macromolecule.

The crosslinked or branched organic, synthetic polymers and/or dendritic polymers preferably have a structure which is as spherical as possible and which is brought about by the crosslinking, a dendritic structure or both; a further substantial feature is the content of hydrophilic groups, preferably urea, urethane, ester, ether, amido, carbonate or acid, in particular carboxyl, groups, amino groups or hydroxyl groups, which result in stable dispersibility in water; ether, carbonate, acid, in particular carboxyl, groups and hydroxyl groups are preferred; ether groups, carbonate groups and hydroxyl groups are particularly preferred.

The organic polymers are present in particle form; moreover, they are crosslinked and/or have a dendritic structure. Crosslinking is achieved by concomitant use of at least trivalent compounds, compounds having at least three functional groups, at least three groups reactive with these functional groups or at least three groups which are selected from functional and reactive groups being suitable. The use of at least trivalent compounds for the synthesis of polycondensates or polyadducts can also lead to dendritic polymers.

In the context of the present invention, the term “dendritic polymers” comprises very generally polymers which are distinguished by a branched structure and a high functionality.

“Dendrimers” and also “hyperbranched polymers” may be mentioned as essential representatives of the dendritic polymers.

“Dendrimers” (cascade polymers, arborols, isotropically branched polymers, isobranched polymers, starburst polymers) are macromolecules which are uniform at the molecular level and have a highly symmetrical structure. Dendrimers are derived structurally from the star polymers, the individual chains in turn each being branched in a star-like manner. They form from small molecules by a constantly repeating reaction sequence, resulting in one or more branches, on the ends of which there are in each case functional groups which in turn are starting points for further branching. Thus, the number of functional terminal groups multiplies with each reaction step, a spherical prestructure forming at the end. A characteristic feature of the dendrimers is the number of reaction steps (generation) carried out for their synthesis. Owing to their uniform structure, dendrimers have as a rule a defined molar mass.

“Hyperbranched polymers” on the other hand are nonuniform both at the molecular level and structurally and have side chains and side branches of different length and branching and a molar mass distribution.

The so-called ABx monomers are particularly suitable for the synthesis of the hyperbranched polymers. Said monomers have two different functional groups A and B which can react with one another with formation of a link. The functional group A is present only once per molecule and the functional group B twice or more. As a result of the reaction of said ABx monomers with one another, uncrosslinked polymers having regularly arranged branching points form. The polymers have virtually exclusively B groups at the chain ends. Further details can be found, for example, in Journal of Molecular Science, Rev. Macromol. Chem. Phys., C37(3), 555-579 (1997). For a general definition of hyperbranched polymers, reference is also made to P. J. Flory, J. Am. Chem. Soc. 1952, 74, 2718 and H. Frey et al., Chem. Eur. J. 2000, 6, No. 14, 2499.

Hyperbranched polymers, i.e. polymers which are nonuniform at the molecular level and structurally, are preferably used. As a rule, these can be prepared more easily and hence more economically than dendrimers.

In the context of the invention, star polymers are also included among the dendritic polymers.

Star polymers are polymers in which three or more chains emanate from a center. The center may be a single atom or a group of atoms.

The dendritic polymers used according to the invention preferably have a degree of branching (DB), corresponding to the sum of the average number of dendritic links and terminal units divided by the sum of the average number of total links (dendritic, linear and terminal links) multiplied by 100, or from 10 to 100%, preferably from 10 to 90% and in particular from 10 to 80%. For the definition of “degree of branching”, reference is made to H. Frey et al., Acta Polym. 1997, 48, 30.

Suitable polymers are those which are formed by polycondensation or polyaddition (polycondensates or polyadducts) or obtainable by polymerization of ethylenically unsaturated compounds. Polycondensates or polyadducts are preferred. Polycondensation is understood as meaning the repeated chemical reaction of functional compounds with suitable reactive compounds with elimination of low molecular weight compounds, such as water, alcohol (in particular methyl or ethyl alcohol), HCl, etc. Polyaddition is understood as meaning repeated chemical reaction of functional compounds with suitable reactive compounds without elimination of compounds.

Suitable polyadducts are in particular polyurethanes, polyureaurethanes or polyureas, as are obtainable by reaction of polyfunctional isocyanates with polyfunctional hydroxy compounds and/or polyfunctional amino compounds. Polyether polyols, which can be obtained in particular by a ring-opening polyaddition reaction of, for example, glycidol or hydroxymethyloxetanes with polyfunctional alcohols may furthermore be mentioned by way of example.

Furthermore, polymers based on ethers, amines, esters, carbonates and amides, and mixed forms thereof, such as, for example, esteramides, etheramines, amidoamines, estercarbonates, etc., are furthermore suitable. In particular, polyethers, polyesters, polyesteramides, polycarbonates or polyestercarbonates can be used as polymers.

Preferred hyperbranched polymers are those based on ethers, amines, esters, carbonates, amides, urethanes and ureas and mixed forms thereof, such as, for example, esteramides, amidoamines, estercarbonates, ureaurethanes, etc. In particular, hyperbranched polyethers, polyesters, polyesteramides, polycarbonates or polyestercarbonates can be used as hyperbranched polymers. Such polymers and processes for their preparation are described in EP 1 141 083, in DE 102 11 664, in WO 00/56802, in WO 03/062306, in WO 96/19537, in WO 03/54204, in WO 03/93343, in WO 05/037893, in WO 04/020503, in DE 10 2004 026 904, in WO 99/16810, in WO 05/026234 and DE 10 2005 009 166.

In the context of the present invention, polycarbonates, in particular dendritic polycarbonates, are particularly preferred. Polycarbonates are polymers having repeating carbonate groups; polycarbonates are obtainable by polycondensation reactions of carbonate-containing compounds with polyhydric hydroxy compounds. Suitable carbonate-containing compounds are, for example, phosgene or preferably esters of carbonic acid, such as dimethyl or diethyl carbonate.

Preferred polyhydric hydroxy compounds are aliphatic hydroxy compounds having two or three hydroxyl groups, preferably three hydroxyl groups; alkoxylated, preferably ethoxylated, compounds which also comprise from 2 to 20 alkoxy groups, preferably ethoxy groups, in addition to the hydroxyl groups are particularly preferred. For example, trimethylolpropane or ethoxylated trimethylolpropane having, for example, from 2 to 20, in particular from 3 to 10, alkoxy or ethoxy groups per hydroxyl group of the trimethylolpropane may be mentioned.

The organic particles preferably have a weight average particle diameter of less than 150 nm, particularly preferably less than 100 nm and very particularly preferably less than 80 nm; the weight average particle diameter is preferably greater than 0.5 nm, in particular greater than 1 nm, particularly preferably greater than 1.5 nm and in particular greater than 2 nm.

The content of the organic particles in the aqueous polymer dispersion is preferably from 0.1 to 30 parts by weight.

The content is particularly preferably at least 0.5 part by weight and very particularly preferably at least 1 part by weight of the organic particles per 100 parts by weight of emulsion polymer.

The content is particularly preferably not more than 20 parts by weight and very particularly preferably not more than 15 or 10 parts by weight of the organic particles per 100 parts by weight of emulsion polymer.

### Regarding the Preparation Process

The preparation of the aqueous polymer dispersion according to the invention is effected by emulsion polymerization.

In emulsion polymerization, ionic and/or nonionic emulsifiers and/or protective colloids or stabilizers are used as surface-active compounds.

The surface-active substance is usually used in amounts of from 0.1 to 10% by weight, based on the monomers to be polymerized.

Water-soluble initiators for the emulsion polymerization are, for example, ammonium and alkali metal salts of peroxodisulfuric acid, e.g. sodium peroxodisulfate, hydrogen peroxide or organic peroxides, e.g. tert-butyl hydroperoxide.

So-called reduction-oxidation (redox) initiator systems are also suitable.

The amount of initiators is in general from 0.1 to 10% by weight, preferably from 0.5 to 5% by weight, based on the monomers to be polymerized. It is also possible to use a plurality of different initiators in the emulsion polymerization.

Regulators can be used in the polymerization, for example in amounts of from 0 to 3 parts by weight, based on 100 parts by weight of the monomers to be polymerized, by means of which the molar mass is reduced. For example, compounds having a thiol group, such as tert-butyl mercaptan, thioglycolic acid ethylacrylic ester, mercaptoethynol, mercaptopropyltrimethoxysilane or tert-dodecyl mercaptan, or regulators without a thiol group, in particular, for example, terpinols, are suitable.

The emulsion polymerization is effected as a rule at from 30 to 130° C., preferably from 50 to 100° C. The polymerization medium may consist of either only water or mixtures of water and liquids miscible therewith, such as methanol. Preferably only water is used. The emulsion polymerization can be carried out both as a batch process and in the form of a feed process, including step or gradient procedure. The feed process in which a part of the polymerization batch is initially taken, heated to the polymerization temperature and prepolymerized and then the remainder of the polymerization batch is fed to the polymerization zone continuously, stepwise or with superposition of a concentration gradient while maintaining the polymerization, usually via a plurality of spatially separate feeds, one or more of which comprise the monomers in pure or in emulsified form, is preferred. In the polymerization, a polymer seed may also be initially taken, for example for better adjustment of the particle size.

The manner in which the initiator is added to the polymerization vessel in the course of the free radical aqueous emulsion polymerization is known to the average person skilled in the art. It can be either completely initially taken in the polymerization vessel or used continuously or stepwise at the rate of its consumption in the course of the free radical aqueous emulsion polymerization. Specifically, this depends on the chemical nature of the initiator system as well as on the polymerization temperature. Preferably, a part is initially taken and the remainder is fed to the polymerization zone at the rate of consumption.

The individual components (e.g. monomers and initiators) can be added to the reactor in the feed process from above, at the side or from below through the reactor bottom.

For removing the residual monomers, initiator is added, usually also after the end of the actual emulsion polymerization, i.e. after a monomer conversion of at least 95%.

According to the invention, the aqueous polymer dispersion is obtainable by emulsion polymerization of monomers in the presence of organic polymer particles (organic particles for short) which are dispersible in the aqueous phase without surface-active assistants. Preferably, the organic particles are dispersed in the aqueous phase without surface-active assistants.

Accordingly, the emulsion polymerization of the monomers is preferably carried out in the presence of organic particles. The organic particles can be initially taken in the polymerization batch before the beginning of the emulsion polymerization or can be added during the emulsion polymerization. The addition of the organic particles can be effected continuously over the entire duration of the polymerization or over a limited time interval. The organic particles can also be added in one or more batches during the emulsion polymerization.

Preferably, the aqueous phase in which the emulsion polymerization is carried out comprises more than 50% by weight of the organic particles, particularly preferably more than 70% by weight, very particularly preferably more than 80% by weight and in particular more than 90% by weight of the organic particles before 90% by weight of all monomers which form the emulsion polymer have polymerized.

The organic particles are particularly preferably added only after the beginning of the polymerization; in general, from 80 to 100% by weight of the organic particles are added after at least 50% by weight of the monomers which form the emulsion polymer have already polymerized.

The high solids content is possible by the process according to the invention.

The content of the emulsion polymer and of the organic particles in the aqueous polymer dispersion (solids content) is altogether at least 50% by weight, in particular at least 55% by weight, preferably at least 58% by weight, particularly preferably at least 60% by weight, or at least 65% by weight, based on the aqueous polymer dispersion. The starting materials (monomers and organic polymer particles) can be polymerized in the desired high concentration, the above solids contents of the polymer dispersion being achieved directly.

### Regarding the Paper Coating Slip

The aqueous polymer dispersion is suitable as a binder, in particular as a binder in paper coating slips.

Paper coating slips comprise, as constituents, in particular
a) binder
b) if appropriate, a thickener
c) if appropriate, a fluorescent or phosphorescent dye, in particular as an optical brightener
d) pigments
e) further assistants, e.g. leveling agents or other dyes.

The above aqueous polymer dispersion which comprises the emulsion polymer and the organic particles is used as the binder. Further binders, for example including natural polymers, such as starch, may be concomitantly used. The proportion of the above aqueous polymer dispersion (calculated as solid, i.e. emulsion polymer and organic particles, without water) is preferably at least 50% by weight, particularly preferably at least 70% by weight or 100% by weight, based on the total amount of binder.

The paper coating slips comprise the binder preferably in amounts of from 1 to 50 parts by weight, particularly preferably from 5 to 20 parts by weight, of binder based on 100 parts by weight of pigment.

Suitable thickeners b) are synthetic polymers, in particular celluloses, preferably carboxymethylcellulose.

Here, the term pigment d) is understood as meaning inorganic solids. These solids as pigments are responsible for the color of the paper coating slip (in particular white) and/or have only the function of an inert filler. In general, the pigments are white pigments, e.g. barium sulfate, calcium carbonate, calcium sulfoaluminate, kaolin, talc, titanium dioxide, zinc oxide, chalk or coating clay or silicates.

The paper coating slip can be prepared by customary methods.

The paper coating slips according to the invention have a low viscosity and are suitable for the coating of, for example, base paper or cardboard. The coating and subsequent drying can be effected by customary methods. The coated papers or cardboard have good performance characteristics; in particular, they can also be readily printed in the known printing processes, such as flexographic, letterpress, gravure or offset printing. Particularly in the offset process, they result in high pick resistance and rapid and good ink and water acceptance. The papers coated with the paper coating slips are very suitable for use in all printing processes, in particular in the offset process.

### EXAMPLES

### General

The Brookfield viscosity was measured at 100 rpm and is stated in mPa·s.

### Example 1

### Preparation of a Dendritic Polycarbonate

335 g of trimethylolpropane, which was randomly grafted with 12 ethylene oxide units, 59.1 g of diethyl carbonate and 0.5 g of potassium hydroxide were initially taken in a three-necked flask equipped with a stirrer, reflux condenser and internal thermometer, and the mixture was heated to 140° C. and stirred at this temperature for 3.5 h. The temperature of the reaction mixture decreased with progressing reaction time, owing to the onset of evaporative cooling of the ethanol liberated. The reflux condenser was then exchanged for a descending condenser, the alcohol was distilled off and the temperature of the reaction mixture was slowly increased to 160° C. The total amount of alcohol distilled off was about 40 g. One equivalent of 85% strength aqueous phosphoric acid, based on KOH, was then added, the pressure was reduced to 40 mbar and the reaction mixture was freed from volatile fractions at 140° C. for 10 min while passing in nitrogen.

The reaction product was cooled to room temperature and then analyzed by gel permeation chromatography; the mobile phase was dimethylacetamide, and polymethyl methacrylate (PMMA) was used as standard. The number average Mn of 2700 Da and a weight average Mw of 5600 Da were obtained.

### Preparation of the Concentrated Copolymer Dispersions

Copolymer Dispersion D1 (with Dendritic Polycarbonate)

220 g of demineralized water and 70 g of a 33% strength by weight polystyrene seed (particle size 30 nm, with 16 parts by weight of emulsifier Disponil LDPS 20) and in each case 4% by weight of the feeds 1A and 1B were initially taken in at room temperature and under a nitrogen atmosphere in a 6 l pressure reactor equipped with an MIG stirrer and three metering apparatuses. Thereafter, the reactor content was heated to 90° C. with stirring (180 rpm), and, on reaching 85° C., 66 g of a 7% strength by weight aqueous sodium persulfate solution were added. After 10 minutes beginning at the same time, the total amount of feed 1A and feed 1B was metered in continuously in the course of 240 minutes and feed 2 in the course of 270 minutes, at constant flow rates. The streams of feed 1A and feed 1B were homogenized briefly before entry into the reactor over the entire metering time. 180 minutes after the start of the feeds, feed 1C was metered in continuously in the course of 20 minutes at constant flow rates. After the end of all feeds, the reactor content was allowed to continue reacting for a further hour at 90° C. Thereafter, the reactor content was cooled to room temperature and the pressure container was let down to atmospheric pressure. The coagulum formed was separated off from the dispersion by filtration over a sieve (mesh size 100 microns).

After measurement of the viscosity (see below), the pH was adjusted to 6.5 at 25% strength by weight aqueous ammonia solution and the solids content was adjusted to 56.5% with demineralized water.

Feed 1A
Homogeneous mixture of

| | |
|---|---|
| 1105 g | of demineralized water |
| 61 g | of a 15% strength by weight aqueous sodium dodecylsulfate solution |
| 26 g | of Dowfax 2A1 from Dow Chemicals (45% strength by weight) |
| 92 g | of acrylic acid |

Feed 1B
Homogeneous mixture of

| | |
|---|---|
| 1426 g | of styrene |
| 28 g | of tert-dodecyl mercaptan |
| 782 g | of butadiene |

Feed 1C

| | |
|---|---|
| 383 g | of a 60% strength by weight aqueous solution of the polycarbonate from |
| | example 1 |

Feed 2

| | |
|---|---|
| 263 g | of a 7% strength by weight aqueous sodium persulfate solution |

The aqueous copolymer dispersion D1 obtained had a solids content of 56.5% by weight, based on the total weight of the aqueous dispersion. The glass transition temperature was determined as 15° C. and the particle size as 157 nm. The viscosities before/after neutralization are shown in table 1.

### Comparative Dispersion CD

220 g of demineralized water and 70 g of a 33% strength by weight polystyrene seed (particle size 30 nm, with 16 parts by weight of emulsifier Disponil LDPS 20) and in each case 4% by weight of the feeds 1A and 1B were initially taken in at room temperature and under a nitrogen atmosphere in a 6 l pressure reactor equipped with an MIG stirrer and three metering apparatuses. Thereafter, the reactor content was heated to 90° C. with stirring (180 rpm), and, on reaching 85° C., 66 g of a 7% strength by weight aqueous sodium persulfate solution were added. After 10 minutes beginning at the same time, the total amount of feed 1A and feed 1B was metered in continuously in the course of 240 minutes and feed 2 in the course of 270 minutes, at constant flow rates. The streams of feed 1A and feed 1B were homogenized briefly before entry into the reactor over the entire metering time. Thereafter, the reactor content was allowed to continue reacting for a further hour at 90° C. Thereafter, the reactor content was cooled to room temperature and the pressure container was let down to atmospheric pressure. The coagulum formed was separated off from the dispersion by filtration over a sieve (mesh size 100 microns).

After measurement of the viscosity (see below), the pH was adjusted to 6.5 with 25% strength by weight aqueous ammonia solution and the solids content was adjusted to 56.5% with demineralized water.

Feed 1A
Homogeneous mixture of

| | |
|---|---|
| 1093 g | of demineralized water |
| 61 g | of a 15% strength by weight aqueous sodium dodecylsulfate solution |
| 26 g | of Dowfax 2A1 from Dow Chemicals (45% strength by weight) |
| 92 g | of acrylic acid |

Feed 1B
Homogenenous mixture of

| | |
|---|---|
| 1426 g | of styrene |
| 28 g | of tert-dodecyl mercaptan |
| 782 g | of butadiene |

Feed 2

| | |
|---|---|
| 263 g | of a 7% strength by weight aqueous sodium persulfate solution |

The aqueous copolymer dispersion CD obtained had a solids content of 56.5% by weight, based on the total weight of the aqueous dispersion. The glass transition temperature was determined as 13° C. and the particle size as 159 nm. The viscosities before/after neutralization are shown in table 1.

The solids contents were determined by drying a defined amount of the respective aqueous copolymer dispersion (about 5 g) at 140° C. in a drying oven to constant weight. In each case two separate measurements were carried out. The values stated in the examples are the mean value of these two measured results.

The glass transition temperature was determined according to DIN 53765 by means of a DSC820 apparatus, series TA8000, from Mettler-Toledo Int. Inc.

The mean particle diameter of the polymer particles was determined by dynamic light scattering on a 0.005 to 0.01% strength by weight aqueous polymer dispersion at 23° C. by means of an Autosizer IIC from Malvern Instruments, England. The mean diameter of a cumulative evaluation (cumulant z-average) of the measured autocorrelation function (ISO standard 13321) is stated.

The Brookfield viscosity was determined according to DIN EN ISO 2555 using spindle 3 at 20 and 100 rpm, 23° C., 60 sec.

The pH was determined according to DIN ISO 976. The viscosity was measured before and after adjustment of the pH to 6.5.

TABLE 1

| | D1 | CE |
|---|---|---|
| Solids content [%] | 56.5 | 56.5 |
| pH value | 6.5 | 6.5 |
| Particle size [nm] | 157 | 159 |
| Viscosity at 20 rpm before neutralization | 3000 | 5250 |
| Viscosity at 100 rpm before neutralization | 1480 | 2100 |
| Viscosity at 20 rpm after neutralization | 2200 | 5280 |
| Viscosity at 100 rpm after neutralizaiton | 1240 | 2150 |

### Coating Slip Preparation

The appropriate amounts of the binders were added according to the formulation to an aqueous dispersion of pigments and homogenization was effected using a high-speed stirrer. In the same way, further prescribed starting materials are also incorporated. Synthetic cobinders or thickeners are expediently added as a last component, the amount being chosen so that the desired viscosity is achieved.

The viscosity is tested according to Brookfield, DIN EN ISO 2555, RTV at 100 rpm, 23° C., the spindle size according to the description depending on the viscosity present.

The coating slips were adjusted to pH 9 with 10% strength NaOH.

In the offset test, a coated paper strip was printed on several times at short time intervals using a prüfbau printability tester (MZ II). A few runs result in picking, which leads to dots and spots on the printed paper. The result is stated as the number of printing processes up to the occurrence of the initial picking.

The water retention according to Gradek indicates how fast a coating slip is dewatered. Rapidly watering is equivalent to poor running properties on the coating machine. The coating slip is present at a slight excess pressure (0.5 bar) in a tube which is closed at the bottom by a polycarbonate membrane having a defined pore size (5 μm, diameter 47 mm). The water passing through is absorbed by filter paper. The less water released, the better is the water retention and the better are the running properties of the coating slip. The amount of water is stated in grams/square meter.

The high shear viscosity is tested using rotational viscometers (in this case rotation viscometer Rheostress 600 from ThermoHaake). A low high-shear viscosity is equivalent to good running properties at high machine speeds (high shear rates at the blade) and is stated in mPa·s.

TABLE 2
Results

| | Solids content | Viscosity of | Coating slip | Coating slip | Coating slip |
|---|---|---|---|---|---|
| | of the starting | the starting | based on | based on | based on |
| | materials | materials | D1 (parts by | CD (parts by | Styronal (parts |
| | (% by weight) | (mPa · s) | weight, solid) | weight, solid) | by weight solid) |
| Hydrocarb 90 ME | 78.3 | | 70 | 70 | 70 |
| Amazon 88 | 74.2 | | 30 | 30 | 30 |
| D1 | 56.5 | 1240 | 10 | | |
| CD | 56.5 | 2510 | | 10 | |
| Styronal ® D 808 | 49.6 | 290 | | | 10 |
| Sterocoll FS (thickener) | 40 | | 0.1 | 0.1 | 0.1 |
| Solids content of the coating | | | 70.6 | | 70.6 |
| slip (coating slips according | | | | | |
| to D1, D2 and CD were diluted) | | | | | |
| Offset test | | | 1-2 times | — | 2 times |
| High shear viscosity | | | 65.5 | | 74.9 |
| Water retention | | | 90.4 | | 91.6 |

The coating slip based on CD could not be handled owing to the high viscosity.

1. An aqueous polymer dispersion having a solids content greater than 50% by weight, obtained by the emulsion polymerization of monomers in the presence of organic polymer particles which are dispersible in the aqueous phase without surface-active assistants.

2. The aqueous polymer dispersion according to claim 1, wherein the emulsion polymer obtained comprises at least 40% by weight of main monomers selected from C₁ to C₂₀ alkyl (meth)acrylates, vinyl esters with carboxylic acids comprising up to 20 carbon atoms, vinylaromatics having up to 20 carbon atoms, ethylenically unsaturated nitrites, vinyl halides, vinyl ethers of alcohols comprising 1 to 10 carbon atoms, and aliphatic hydrocarbons having 2 to 8 carbon atoms and one or two double bonds and mixtures of these monomers.

3. The aqueous polymer dispersion according to claim 1, wherein the emulsion polymer comprises at least 60% by weight of butadiene or mixtures of butadiene and styrene or of at least 60% by weight of C₁ to C₂₀ alkyl (meth)acrylates and mixtures of C₁ to C₂₀ alkyl (meth)acrylates and styrene.

4. The aqueous polymer dispersion according to claim 1, wherein the emulsion polymer comprises at least 60% by weight of butadiene or mixtures of butadiene and styrene.

5. The aqueous polymer dispersion according to claim 1, wherein the organic particles are dispersible in water in a stable manner according to their content of hydrophilic groups.

6. The aqueous polymer dispersion according to claim 1, wherein the organic particles are crosslinked synthetic organic polymers.

7. The aqueous polymer dispersion according to claim 1, wherein the organic particles are dendritic polymers.

8. The aqueous polymer dispersion according to claim 1, wherein the organic particles are crosslinked or dendritic polycarbonates.

9. The aqueous polymer dispersion according to claim 1, wherein the organic particles have a weight average particle diameter of less than 150 nm.

10. The aqueous polymer dispersion according to claim 1, wherein the aqueous polymer dispersion comprises from 0.1 to 30 parts by weight of the organic particles per 100 parts by weight of emulsion polymer.

11. The aqueous polymer dispersion according to claim 1, wherein the polymer dispersion is obtained by a procedure in which the aqueous phase comprises more than 50% by weight of the organic particles before 90% by weight of all monomers which form the emulsion polymer have polymerized.

12. The aqueous polymer dispersion according to claim 1, wherein the polymer dispersion is obtained by a procedure in which the aqueous phase comprises more than 80% by weight of the organic particles before 90% by weight of all monomers which form the emulsion polymer have polymerized.

13. The aqueous polymer dispersion according to claim 1, wherein the content of the emulsion polymer and of the organic particles in the aqueous dispersion is at least 55% by weight altogether.

14. A process for the preparation of aqueous polymer dispersions, wherein the emulsion polymerization is carried out in the presence of organic polymer particles which are dispersed in the aqueous phase without surface-active assistants.

15. A binder in paper coating slips comprising the aqueous polymer dispersion according to claim 1.

16. A paper coating slip comprising the aqueous polymer dispersion according to claim 1.

17. A paper or cardboard coated with a paper coating slip according to claim 16.
